(19) United States
(12) Patent Application Publication
(10) Pub. No.: US 2026/0064454 A1
(43) Pub. Date: Mar. 5, 2026

(54) MACHINE-TUNING SYSTEM AND MACHINE-TUNING METHOD FOR INTEGRATING VIRTUAL SIMULATIONS AND PHYSICAL OPERATIONS

(71) Applicant: DELTA ELECTRONICS, INC., Taoyuan City (TW)

(72) Inventors: Yu-Cheng LAI, Taoyuan City (TW); Keng-Ning CHANG, Taoyuan City (TW); Chia-Jun YU, Taoyuan City (TW)

(21) Appl. No.: 19/059,262

(22) Filed: Feb. 21, 2025

(30) Foreign Application Priority Data
Aug. 29, 2024 (CN) 2024112024918

(51) Int. Cl. G06F 9/455

(52) U.S. Cl. CPC G06F 9/45558; G06F 2009/45579

(57) ABSTRACT

A machine-tuning system and method for integrating virtual simulations and physical operations are provided. An operation programming interface provides pseudo-codes based on a software framework, where the pseudo-codes include codes processing an interactive event operating process, and the software framework is compatible with virtual machine drivers and physical machine drivers. A processor imports the virtual machine drivers into the pseudo-codes, compiles it to be a virtual machine-tuning program and executes the virtual machine-tuning program to control virtual operations of the virtual machine in a 3D virtual environment, and imports the physical machine drivers into the pseudo-codes and compiles to be a physical machine-tuning program and executes the physical machine-tuning program to control physical operations of the physical machine, so a logic of the physical operations of the physical machine and the virtual operations of the virtual machine in the 3D virtual environment is the same.

### BACKGROUND OF THE DISCLOSURE

### Technical Field

The disclosure generally relates to a machine-tuning system and a machine-tuning method, particularly to a machine system and a machine-tuning method for integrating virtual simulations and physical operations.

### Description of Related Art

When users operate the existing machine-tuning system, they need to interrupt the production line and pause the machine during loading and unloading to perform physical machine-tuning in transition situations. However, this operation affects the utilization rate of machines, leading to low production efficiency. During the process of tuning physical machines, operational errors caused by manual handling can easily lead to the risk of machine collisions.

To address the machine-tuning issues with physical machines, some machine-tuning systems have introduced programs that simulate the control of physical machines. Current machine-tuning technologies that incorporate simulation require two sets of different control programs: the virtual machine-tuning program and the physical machine-tuning program. Before implementing the program on physical machines, users need to operate the virtual machine-tuning program to tune the virtual machines. Since the virtual machine-tuning program and the physical machine-tuning program are different, the virtual machine-tuning program cannot be directly applied to physical machines after virtual tuning is completed. To apply the control processes of the virtual machine-tuning program to physical machines, users need to spend additional time converting the virtual machine-tuning program into a format compatible with physical machines, including converting control programs such as manufacturing parameters. This process highlights the low integration between virtual and physical tuning, making it highly labor-consuming and time-consuming.

In addition, existing virtual machine-tuning programs cannot incorporate logical judgments and exception handling into the tuning process, as the content only covers static manufacturing parameters. As a result, they fail to consider all possible scenarios that may occur in virtual machines, which indicates that the physical machine-tuning program also cannot handle logical judgments and exception handling, lacking safety protection mechanisms.

### SUMMARY OF THE INVENTION

An embodiment of the disclosure provides a machine-tuning system for integrating virtual simulations and physical operations including an operation programming interface and a processor. The operation programming interface is configured to provide virtual-physical synchronous operation pseudo-codes based on a software framework, where the virtual-physical synchronous operation pseudo-codes include pseudo-codes that process an interactive event operating process and the software framework is compatible with virtual machine drivers and physical machine drivers. The processor is configured to import the virtual machine drivers into the virtual-physical synchronous operation pseudo-codes and compile the virtual-physical synchronous operation pseudo-codes and the virtual machine drivers to be a virtual machine-tuning program, execute the virtual machine-tuning program to control virtual operations of virtual machines in a 3D virtual environment, and import the physical machine drivers into virtual-physical synchronous operation pseudo-codes and compile the virtual-physical synchronous operation pseudo-codes and the physical machine drivers to be a physical machine-tuning program, execute the physical machine-tuning program to control physical operations of physical machines, so a logic of the physical operations of the physical machines and the logic of the virtual operations of the virtual machines in the 3D virtual environment is the same.

An embodiment of the disclosure provides a machine-tuning method for integrating the virtual simulations and the physical operations, applied to simulated operations and actual physical operations of a unitary interface of virtual machines and physical machines. The machine-tuning method includes providing virtual-physical synchronous operation pseudo-codes based on a software framework, where the virtual-physical synchronous operation pseudo-codes include pseudo-codes that process an interactive event operating process and the software framework is compatible with virtual machine drivers and physical machine drivers; importing the virtual machine drivers into the virtual-physical synchronous operation pseudo-codes and importing the physical machine drivers into virtual-physical synchronous operation pseudo-codes; compiling the virtual-physical synchronous operation pseudo-codes and the virtual machine drivers to be a virtual machine-tuning program, and compiling the virtual-physical synchronous operation pseudo-codes and the physical machine drivers to be a physical machine-tuning program; and executing the virtual machine-tuning program to control virtual operations of virtual machines in a 3D virtual environment, and executing the physical machine-tuning program to control physical operations of physical machines, so a logic of the physical operations of the physical machines and the logic of the virtual operations of the virtual machines in the 3D virtual environment is the same.

### BRIEF DESCRIPTION OF THE DRAWINGS

FIG. 1 is a block diagram of a machine-tuning system for integrating virtual simulations and physical operations according to one embodiment of the present disclosure.

FIG. 2 is a flowchart of a machine-tuning method for integrating the virtual simulations and the physical operations according to one embodiment of the present disclosure.

FIG. 3 illustrates the relationship of a program-operating interface between pseudo-codes and drivers according to one embodiment of the present disclosure.

FIG. 4A and FIG. 4B are flowcharts of the machine-tuning method for integrating the virtual simulations and the physical operations according to one embodiment of the present disclosure.

FIG. 5A and FIG. 5B are flowcharts of the machine-tuning method for integrating the virtual simulations and the physical operations according to the other embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

To resolve the problem of independent program interfaces for respectively tuning virtual machines and physical machines during machine-tuning procedures, the disclosure provides a machine-tuning technique for integrating virtual simulations and physical operations. By implementing the unitary program interface and the same set of pseudo-codes, the machine-tuning procedure is performed synchronously on the virtual machines and the physical machines.

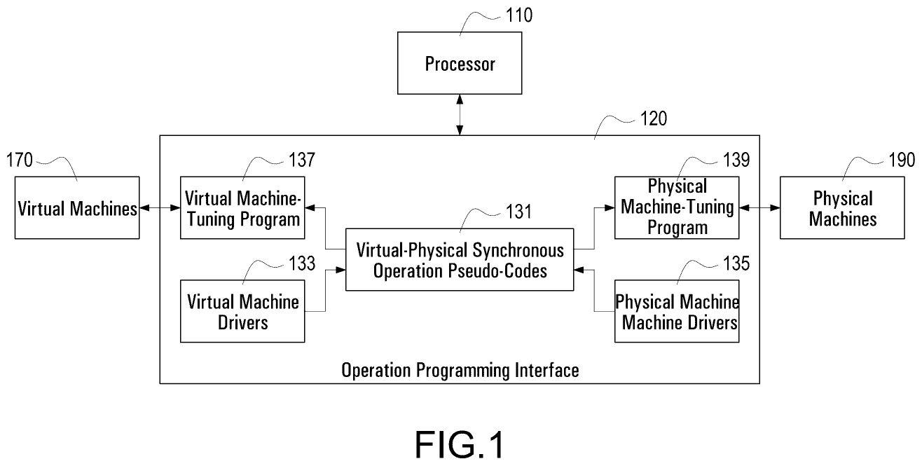

FIG. 1 is a block diagram of a machine-tuning system for integrating virtual simulations and physical operations according to one embodiment of the present disclosure.

The machine-tuning system for integrating virtual simulations and physical operations (hereafter referred to as “machine-tuning system”) includes a processor 110 and an operation programming interface 120.

The operation programming interface 120 provides virtual-physical synchronous operation pseudo-codes 131 based on the software framework. The software framework is compatible with virtual machine drivers and physical machine drivers. In one embodiment, multiple layers from top to bottom of the software framework are the Application, the Hardware Abstract Layer (HAL), and the Device Driver. In the operation programming interface 120, the virtual machine drivers and the physical machine drivers are developed based on the same hardware abstract layer. The virtual machine drivers control simulation operations of the virtual machines in a 3D virtual environment, and the physical machine drivers control physical operations of the physical machines in a physical environment.

The operation programming interface 120 includes virtual-physical synchronous operation pseudo-codes 131, virtual machine drivers 133, physical machine drivers 135, a virtual machine-tuning program 137, and a physical machine-tuning program 139.

In one embodiment, the processor 110 imports the virtual machine drivers 133 into the virtual-physical synchronous operation pseudo-codes 131 and compiles the virtual-physical synchronous operation pseudo-codes 131 and the virtual machine drivers 133 to be the virtual machine-tuning program 137. The processor 110 executes the virtual machine-tuning program 137 to control virtual operations of the virtual machines 170 in the 3D virtual environment.

In one embodiment, the processor 110 imports the physical machine drivers 135 into the virtual-physical synchronous operation pseudo-codes 131 and compiles the virtual-physical synchronous operation pseudo-codes 131 and the physical machine drivers 135 to be the physical machine-tuning program 139. The processor 110 executes the physical machine-tuning program 139 to control physical operations of the physical machines 190.

In one embodiment, the virtual-physical synchronous operation pseudo-codes 131 provided by the operation programming interface 120 includes pseudo-codes for processing an interactive event operating process. The interactive event operating process may be any exception handling, such as component collisions of the virtual machines 170, component collisions of the physical machines 190, foreign object dropping, raw material exhaustion, or triggering safety door of machine tools in the 3D virtual environment or the physical environment. The exception events handling may be dealt with by functions of sensors that are deployed on the virtual-physical synchronous operation pseudo-codes 131.

In the embodiment, because the virtual machine-tuning program 137 and the physical machine-tuning program 139 are generated by the compiling process of the same virtual-physical synchronous operation pseudo-codes 131, the logic of the physical operations of the physical machines 190 is the same as the logic of the virtual operations of the virtual machines 170 in the 3D virtual environment. Hence, as long as the user programs the same set of pseudo-codes, the set of pseudo-codes may be performed to implement the same control logic of the virtual machines 170 and the physical machines 190.

In one embodiment, the processor 110 may be but is not limited to the microprocessor, the Digital Signal Processors (DSP), the Application Specific Integrated Circuit (ASIC), the central processing unit (CPU), the System on Chip (SoC), the Field Programmable Gate Array (FPGA), the network processor chip, or any combination of the elements above.

In one embodiment, the machine-tuning system for integrating virtual simulations and physical operations is implemented in a Computer Numerical Control (CNC) system, and the operation programming interface 120 provides the virtual-physical synchronous operation pseudo-codes 131. After the processor 110 compiles the virtual-physical synchronous operation pseudo-codes 131, the virtual machine drivers 133 may drive the simulated motors or simulated robot arms, and the physical machine drivers 135 may drive the physical motors or real physical robot arms.

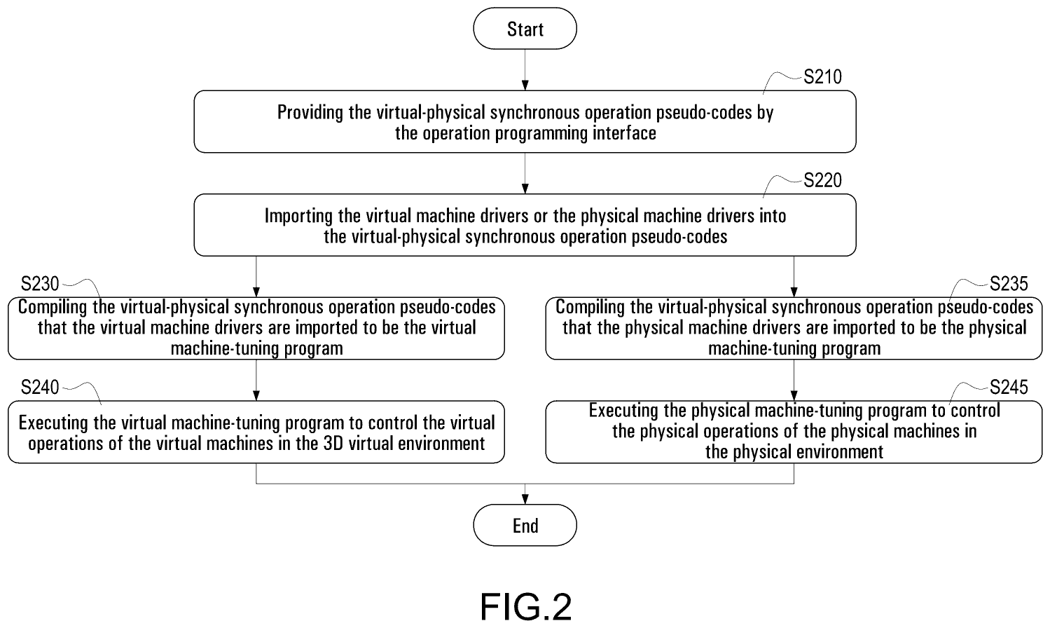

FIG. 2 is a flowchart of a machine-tuning method for integrating the virtual simulations and the physical operations according to one embodiment of the present disclosure. The machine-tuning method for integrating the virtual simulations and the physical operations may be implemented in a unitary interface of the virtual machines 170 and the physical machines 190 to perform simulated operations and physical operations.

In step S210, providing the virtual-physical synchronous operation pseudo-codes 131 by the operation programming interface 120 is performed.

In step S220, importing the virtual machine drivers 133 or the physical machine drivers 135 into the virtual-physical synchronous operation pseudo-codes 131 is performed.

In step S230, compiling the virtual-physical synchronous operation pseudo-codes 131 that the virtual machine drivers 133 are imported to be the virtual machine-tuning program 137 by the processor 110 is performed.

In step S235, compiling the virtual-physical synchronous operation pseudo-codes 131 that the physical machine drivers 135 are imported to be the physical machine-tuning program 139 by the processor 137 is performed.

In step S240, executing the virtual machine-tuning program 137 by the processor 110 to control the virtual operations of the virtual machines 170 in the 3D virtual environment is performed.

In step S245, executing the physical machine-tuning program 139 by the processor 110 to control the physical operations of the physical machines 190 in the physical environment is performed.

In one embodiment, the operation processes (steps S220, S230, and S240) of the virtual machines are performed before or after, or in parallel with the operation processes (steps S220, S235, and S245) of the physical machines.

The virtual machine-tuning for a curl-bending manufacturing process is taken as an example. The virtual machine-tuning program 137 receives the initial manufacturing parameters, such as curl bending, material coefficient/thickness/cross-sectional area dimensions, two-wheel diameter span, and initial servo model parameters. After the manufacturing parameters are inputted to the virtual machine-tuning program 137, the processor 110 executes the virtual servo model of the virtual machine-tuning program 137 and monitors the bending force/tension/color variation in the 3D virtual environment to determine whether to update the manufacturing parameters. Before the virtual machine-tuning is completed, the manufacturing parameters are continuously updated to the virtual servo model until the virtual machine-tuning is completed. On the other hand, the virtual machine-tuning program 137 may determine whether the interactive event operating process is triggered, such as the trigger of the raw material exhaustion or the foreign object dropping (by sensors). If any interactive event operating process is triggered, the virtual machine-tuning program 137 will be paused to clear the faults.

The virtual machine-tuning for taking out/feeding raw materials in the CNC is taken as an example. The virtual machine-tuning program 137 receives the initial manufacturing parameters, such as the model number of a robot arm (associated with the motion model of the robot arm), an imported product (associated with the subject of the virtual machine-tuning), and a wiring definition of virtual signals (associated with an emergency button of the machine tuning). The processor 110 executes a three-dimensional virtual demonstrator of the virtual machine-tuning program 137 to perform the point teaching until the point teaching is well-defined. On the other hand, the virtual machine-tuning program 137 determines whether the interactive event operating process is triggered, such as the trigger of the raw material exhaustion or the foreign object dropping (by sensors). If any interactive event operating process is triggered, the virtual machine-tuning program 137 will be paused to clear the faults.

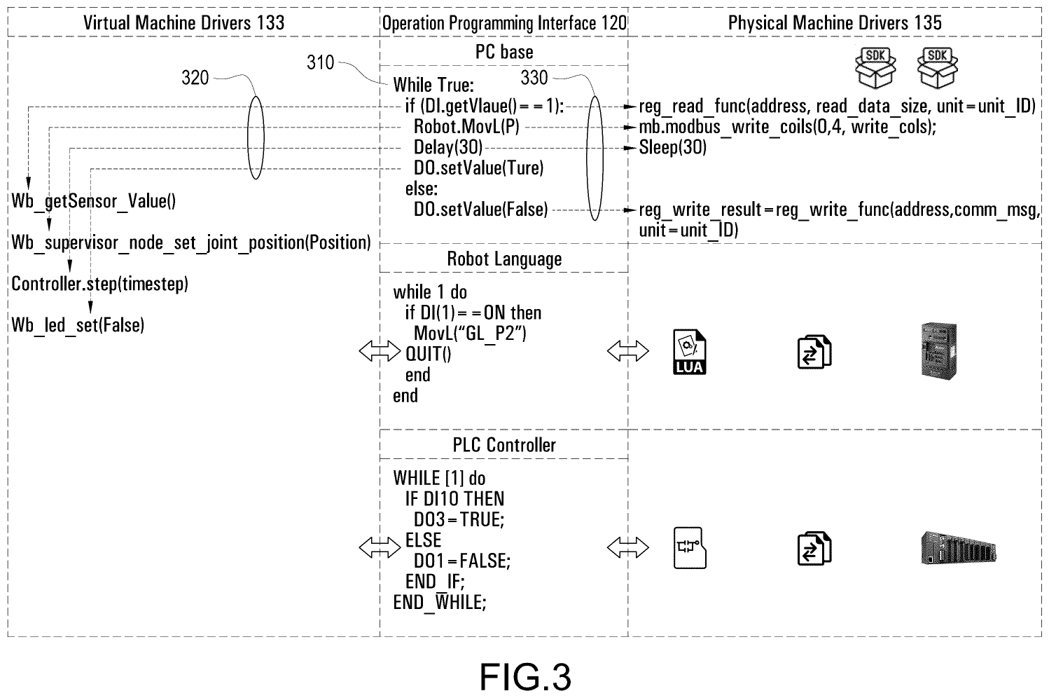

FIG. 3 illustrates the relationship of a program-operating interface between pseudo-codes and drivers according to one embodiment of the present disclosure.

The operation programming interface 120 provides the application programming interface with functions for user coding programs and determines the compiled content of the programs by importing the commands of the drivers.

In one embodiment, the operation programming interface 120 may be pseudo-codes 310 executed on personal computers (PC base), robotic programming languages (Robot Language), or programmable logic controllers (PLC Controller). The pseudo-codes 310 may be the virtual-physical synchronous operation pseudo-codes 131 of FIG. 1.

In one embodiment, after importing the virtual machine drivers 133, the processor 110 calls program codes 320 of the virtual machine drivers 133 through the pseudo-codes 310. When executing the physical machine-tuning program 139, the processor 110 uses virtual machine models that are established in advance in the 3D virtual environment to perform virtual machine-tuning operations of the virtual machines 170.

In one embodiment, after importing the physical machine drivers 135, the processor 110 calls the program codes 330 of the physical machine drivers 135 through the pseudo-codes 310. When executing the physical machine-tuning program 139, the processor 110 uses physical engines and operation models that are established in advance in the physical environment to perform physical machine-tuning operations of the physical machines 190.

The pseudo-codes 310 include design commands of multiple modes in a production line, commands of operating the multiple nodes, and commands of processing the interactive event operating processes. Each node respectively corresponds to a virtual component (such as a component of the physical machines 190, a simulated sensor, a virtual production line component, and so on) and a physical component of the physical environment (such as a component of physical machines 190, a physical sensor, a physical production line component, and so on). The interactive event operating process may be the exception event of each node or the exception event between nodes (such as the foreign object dropping, the raw material exhaustion, or triggering the safety door of machine tools).

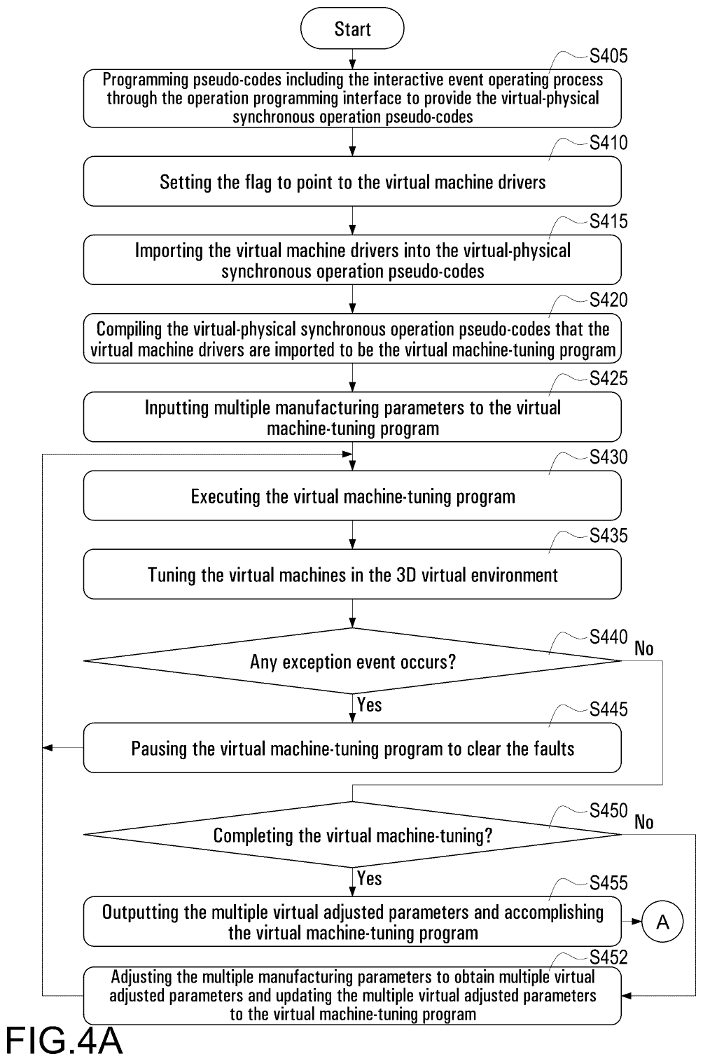

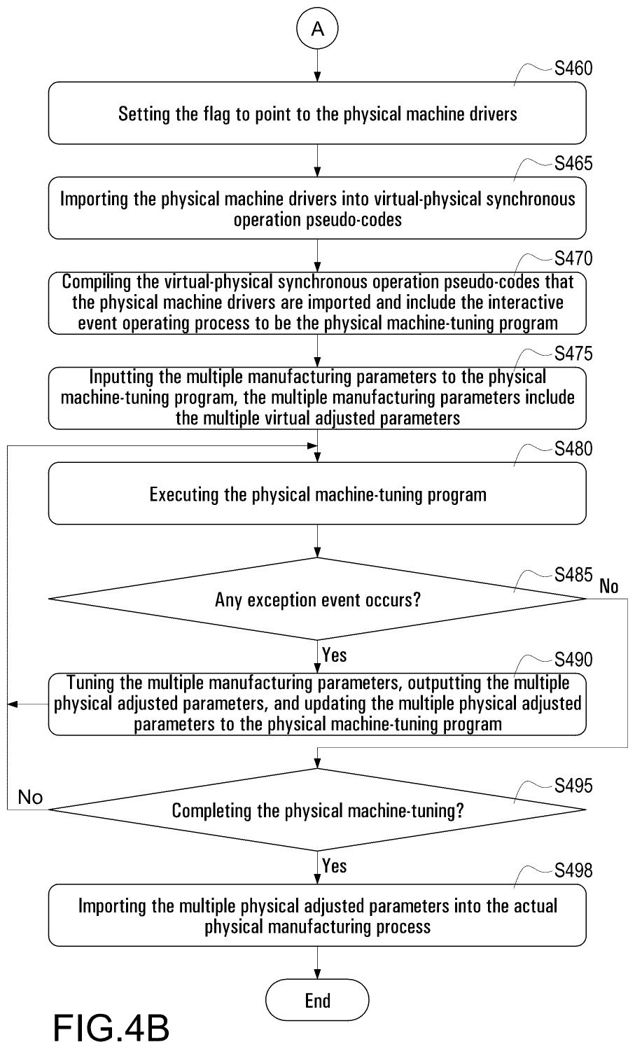

FIG. 4A and FIG. 4B are flowcharts of the machine-tuning method for integrating the virtual simulations and the physical operations according to one embodiment of the present disclosure.

In the embodiment, a flag is set through the operation programming interface 120, and the flag points to the machine-tuning procedure of the virtual machines 170 or the machine-tuning procedure of the physical machines 190. In the entire procedure, the user just handles the same operation programming interface 120, the machine-tuning procedure may be switched between the virtual machine-tuning and the physical machine-tuning.

For the sake of understanding, the embodiment of executing the virtual machine-tuning program 137 first, and then executing the physical machine-tuning program 139 is provided as one example, however, the execution order is not limited herein.

In step S405, programming, through the operation programming interface 120, the virtual-physical synchronous operation pseudo-codes 131 including the interactive event operating process is performed.

In step S410, setting the flag to point to the virtual machine drivers 133 is performed.

In step S415, importing, by the processor 110, the virtual machine drivers 133 into the virtual-physical synchronous operation pseudo-codes 131 according to the setting of the flag is performed.

In step S420, compiling the virtual-physical synchronous operation pseudo-codes 131 that the virtual machine drivers 133 are imported to be the virtual machine-tuning program 137 is performed.

In step S425, inputting multiple manufacturing parameters to the virtual machine-tuning program 137 by the processor 110 is performed. In one embodiment, the manufacturing parameters may be the robot parameters (such as pose points of the robot arms) of the virtual machines 170, the motor parameters (such as rotation speeds), the tension force, and the like, which are the static parameters of the production manufacture process.

In step S430, executing the virtual machine-tuning program 137 by the processor 110 is performed. At this time, the process enters the machine-tuning simulation of the virtual machines 170 in the 3D virtual environment.

In step S435, the virtual machines 170 are tuned in the 3D virtual environment. At the moment, the users may operate the virtual machine-tuning based on their experience.

In step S440, determining whether any exception event occurs by the processor 110 is performed. The exception event may be the foreign object dropping, the raw material exhaustion, triggering the safety door of machine tools, and so on. The determinations and the corresponding responses of the exception events may be defined in advance by the users and programmed in the virtual-physical synchronous operation pseudo-codes 131. It should be noted that the exception events during the process occur in the simulated scenario of the 3D virtual environment.

If any exception event occurs while the virtual machine-tuning program 137 is executed, the process goes to step S445; otherwise, the process goes to step S450.

In step S445, pausing the virtual machine-tuning program 137 by the exception events to clear the faults is performed. For example, during the moving of the robot arm of the virtual machines 170 taking materials, the robot arm collides with a feed table due to the position deviation, which belongs to the exception event. In the meantime, the virtual machine-tuning program 137 pauses the process because of the exception event. In one embodiment, the users may program the virtual-physical synchronous operation pseudo-codes 131 by the operation programming interface 120 during the pausing process to modify the conditions of the virtual environment (step S405) and then make the program re-compiled.

After the exception event is clear, the process goes back to step S430, and the virtual machine-tuning program 137 is performed.

In step S450, determining whether the virtual machine-tuning program 137 completes the virtual machine-tuning by the processor 110 is performed. If the determination is negative, the process goes to step S452; otherwise, the process goes to step S455.

In step S452, while performing the virtual machine-tuning program 137, the processor 110 adjusts the multiple manufacturing parameters to obtain multiple virtual adjusted parameters and updates the multiple virtual adjusted parameters to the virtual machine-tuning program 137. Then, the process goes back to step S430 and continues to execute the virtual machine-tuning program 137.

In step S455, after completing the virtual machine-tuning, the processor 110 outputs the multiple virtual adjusted parameters and accomplishes the virtual machine-tuning program 137. In one embodiment, the multiple virtual adjusted parameters at this time are the latest after the virtual machine-tuning program 137 is accomplished, that is, the parameters that are well-tuned and suitable for applying to the physical machines 190.

In step S460, setting the flag to point to the physical machine drivers 135 is performed.

In step S465, importing the physical machine drivers 135 into virtual-physical synchronous operation pseudo-codes 131 according to the setting of the flag by the processor 110 is performed.

In step S470, compiling the virtual-physical synchronous operation pseudo-codes 131 that the physical machine drivers 135 are imported and includes the interactive event operating process to be the physical machine-tuning program 139 is performed. In one embodiment, at this time the virtual-physical synchronous operation pseudo-codes 131 are the program codes that have been tested for the exception events handling and the virtual machine-tuning of the simulation environment, and satisfy the actual physical field of the on-site conditions.

In step S475, inputting the multiple manufacturing parameters to the physical machine-tuning program 139 by the processor 110 is performed. In one embodiment, the manufacturing parameters include the multiple virtual adjusted parameters that are outputted in step S455.

In step S480, executing the physical machine-tuning program 139 by the processor 110 is performed. At this time, the users may operate the physical machine-tuning based on their experience.

In step S485, determining whether any exception event occurs by the processor 110 is performed. The exception event may be the foreign object dropping, the raw material exhaustion, triggering the safety door of machine tools, and so on. The determinations and the corresponding responses of the exception events may be defined in advance by the users and programmed in the virtual-physical synchronous operation pseudo-codes 131. It should be noted that at this time if any exception event occurs, it indicates that the exception event occurs in the actual physical field of the physical environment. Hence, the exception events that occur at this time make the on-site condition endangered and all the physical operations have to be paused to prevent further danger or property damage.

If the physical machine-tuning program 139 determines that an exception event is encountered, the process goes to step S490; otherwise, the process goes to step S495.

In step S490, adjusting the multiple manufacturing parameters, outputting the multiple physical adjusted parameters, and updating the multiple physical adjusted parameters to the physical machine-tuning program 139 by the processor 110, to clear the encountered exception events by modifying the manufacturing parameters. Then, the process goes back to step S480 to continue the physical machine-tuning program 139.

In step S495, determining whether the physical machine-tuning program 139 completes the physical machine-tuning by the processor 110 is performed. If the determination is negative, the process goes back to step S480; otherwise, the process goes to step S498.

In step S498, after completing the physical machine-tuning, the processor 110 outputs the multiple physical adjusted parameters and accomplishes the physical machine-tuning program 139. In one embodiment, at this time the multiple physical adjusted parameters are the latest after the physical machine-tuning program 139 is accomplished, that is, the parameters that are well-tuned and suitable for applying to the physical machines 190. It should be noted that the manufacturing parameters may be adjusted during the physical machine-tuning program 139 being executed, so the data of the multiple physical adjusted parameters outputted in step S498 may be different from the data of the multiple virtual adjusted parameters outputted in step S455. In one embodiment, the multiple physical adjusted parameters outputted in step S498 may be fed back to the virtual machine-tuning program 137, so the virtual machine-tuning program 137 may be optimized by the latest parameters.

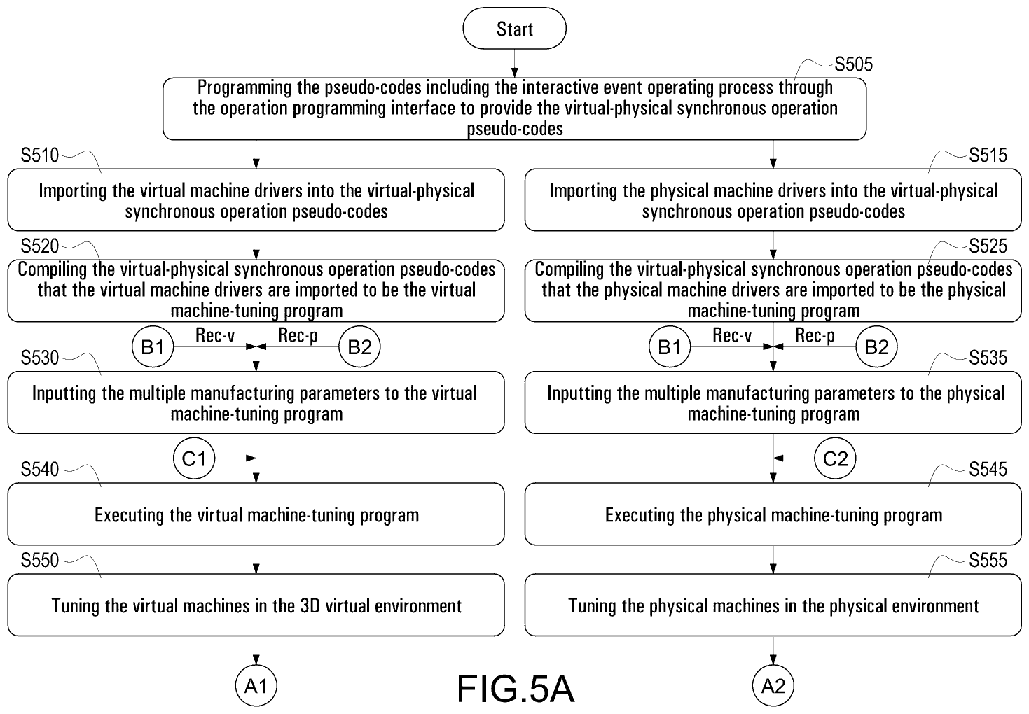

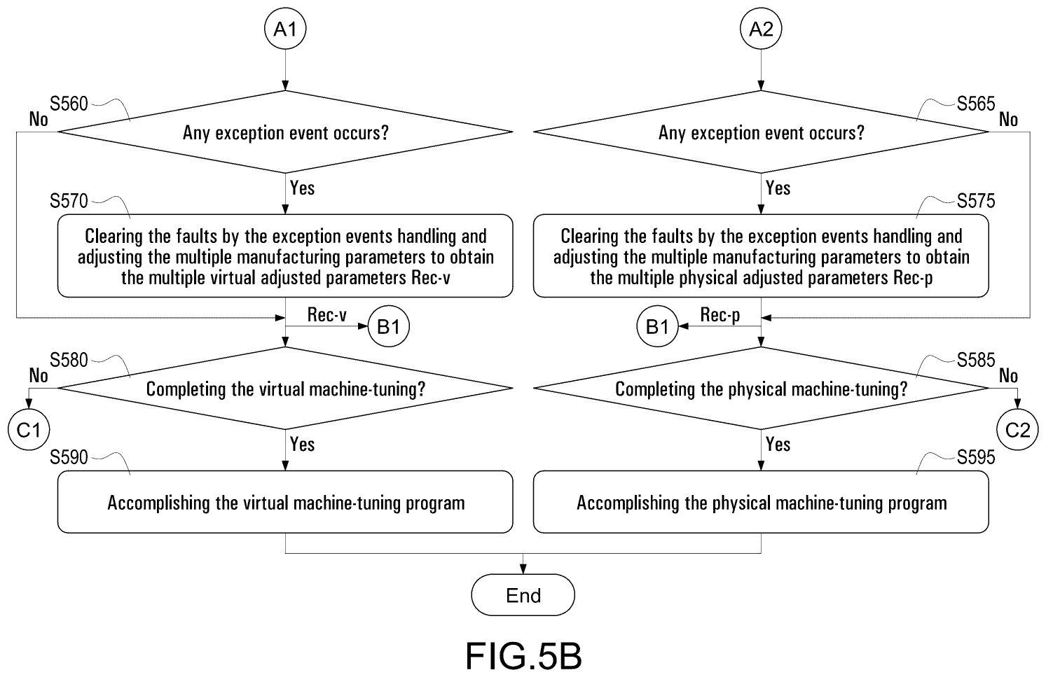

FIG. 5A and FIG. 5B are flowcharts of the machine-tuning method for integrating the virtual simulations and the physical operations according to the other embodiment of the present disclosure.

The following provides an embodiment that the virtual machine-tuning program 137 and the physical machine-tuning program 139 execute in parallel and immediately feed back the parameters to another machine-tuning program to repeatedly optimize the virtual machine-tuning programs 137 and the physical machine-tuning programs 139.

In step S505, programming, through the operation programming interface 120, the pseudo-codes including the interactive event operating process to provide the virtual-physical synchronous operation pseudo-codes 131 is performed.

The left branch of the flowchart is the machine-tuning process of the virtual machines 170, and the right branch of the flowchart is the machine-tuning process of the physical machines 190. The left branch and the right branch may execute before or after the other, that is, the execution order is not the matter, and each step may be performed interleaved with each other. In the process, the virtual adjusted parameters that are adjusted by the virtual machine-tuning program 137 of the left branch may be immediately fed to the physical machine-tuning program 139 of the right branch, and vice versa (i.e., the physical adjusted parameters that are adjusted by the physical machine-tuning program 139 of the right branch may be also immediately fed to the virtual machine-tuning program 137 of the left branch.) Although the virtual adjusted parameters fed to the physical machine-tuning program 139 and the physical adjusted parameters fed to the virtual machine-tuning program 137 may be intermediately generated adjusted parameters, the machine-tuning process of the machine-tuning system (both the virtual and physical machine-tuning) is speeded up by feeding the adjusted parameters of the other machine-tuning program to improve the execution efficiency of the machine-tuning system.

In step S510, importing the virtual machine drivers 133 into the virtual-physical synchronous operation pseudo-codes 131 is performed.

In step S520, compiling the virtual-physical synchronous operation pseudo-codes 131 that the virtual machine drivers 133 are imported to be the virtual machine-tuning program 137 is performed.

In step S530, inputting multiple manufacturing parameters to the virtual machine-tuning program 137 by the processor 110 is performed.

In step S540, executing the virtual machine-tuning program 137 by the processor 110 is performed. At this time, the process enters the machine-tuning simulation of the virtual machines 170 in the 3D virtual environment.

In step S550, the virtual machines 170 is tuned in the 3D virtual environment by the processor 110.

In step S560, determining whether any exception event occurs by the processor 110 is performed. If any exception event occurs while the virtual machine-tuning program 137 is executed, the process goes to step S570; otherwise, the process goes to step S580.

In step S570, pausing the virtual machine-tuning program 137 by the processor 110 according to the exception events handling to clear the faults and adjusting the multiple manufacturing parameters to obtain the multiple virtual adjusted parameters Rec-v is performed.

In step S580, determining whether the virtual machine-tuning program 137 completes the virtual machine-tuning by the processor 110 is performed. If the determination is negative, the process goes back to step S540; otherwise, the process goes to step S590.

In step S590, after completing the virtual machine-tuning, the processor 110 outputs the multiple virtual adjusted parameters which may be the final version, and accomplishes the virtual machine-tuning program 137.

On the other hand, in step S515, importing the physical machine drivers 135 into the virtual-physical synchronous operation pseudo-codes 131 by the processor 110 is performed.

In step S525, compiling the virtual-physical synchronous operation pseudo-codes 131 that the physical machine drivers 135 are imported and includes the interactive event operating process to be the physical machine-tuning program 139 is performed.

In step S535, inputting the multiple manufacturing parameters to the physical machine-tuning program 139 by the processor 110 is performed.

In step S545, executing the physical machine-tuning program 139 by the processor 110 is performed.

In step S555, tuning the physical machines in the physical environment by the processor 110 is performed.

In step S565, determining whether any exception event occurs by the processor 110 is performed. If any exception event occurs while the physical machine-tuning program 139 is executed, the process goes to step S575; otherwise, the process goes to step S585.

In step S575, pausing the physical machine-tuning program 139 by the processor 110 according to the exception events handling to clear the faults and adjusting the multiple manufacturing parameters to obtain the multiple physical adjusted parameters Rec-p is performed.

In step S585, determining whether the physical machine-tuning program 139 completes the machine-tuning of the physical machines 190 by the processor 110 is performed. If the determination is negative, the process goes back to step S545 and continues the execution of the physical machine-tuning program 139; otherwise, the process goes to step S595.

In step S595, after completing the physical machine-tuning, the processor 110 outputs the multiple physical adjusted parameters which may be the final version, and accomplishes the physical machine-tuning program 139. In one embodiment, after completing the physical machine-tuning, the multiple physical adjusted parameters which may be the final version, and the interactive event operating process that handles the exception events are imported into the actual physical manufacturing process.

In one embodiment, after adjusting the multiple manufacturing parameters to obtain the multiple virtual adjusted parameters Rec-v (step S570), the processor 110 feeds back the multiple virtual adjusted parameters Rec-v to the physical machine-tuning program 139. After the physical machine-tuning program 139 receives the multiple virtual adjusted parameters Rec-v, the processor 110 uses the multiple manufacturing parameters (including the multiple virtual adjusted parameters Rec-v)(step S535) to execute the physical machine-tuning program 139 (step S545).

In one embodiment, after receiving the multiple physical adjusted parameters Rec-p (step S575), the processor 110 feeds back the multiple physical adjusted parameters Rec-p to the physical machine-tuning program 139. After the physical machine-tuning program 139 receives the multiple physical adjusted parameters Rec-p, the processor 110 uses the multiple manufacturing parameters (including the multiple physical adjusted parameters Rec-p) (step S535) to execute the physical machine-tuning program 139 (step S545).

In one embodiment, the multiple manufacturing parameters include the multiple virtual adjusted parameters Rec-v and the multiple physical adjusted parameters Rec-p. The processor 110 refers to the multiple virtual adjusted parameters Rec-v and the multiple physical adjusted parameters Rec-p to execute the physical machine-tuning program 139 (step S545).

In one embodiment, after adjusting the multiple manufacturing parameters to obtain the multiple physical adjusted parameters Rec-p (step S575), the processor 110 feeds back the multiple physical adjusted parameters Rec-p to the virtual machine-tuning program 137. After the virtual machine-tuning program 137 receives the multiple physical adjusted parameters Rec-p, the processor 110 uses the multiple manufacturing parameters (including the multiple physical adjusted parameters Rec-p) to execute the virtual machine-tuning program 137 (step S540).

In one embodiment, after obtaining the multiple virtual adjusted parameters Rec-v (step S570), the processor 110 feeds back the multiple virtual adjusted parameters Rec-v to the virtual machine-tuning program 137. After the virtual machine-tuning program 137 receives the multiple virtual adjusted parameters Rec-v (step S530), the processor 110 uses the multiple manufacturing parameters (including the multiple virtual adjusted parameters Rec-v) to execute the virtual machine-tuning program 137 (step S540).

In one embodiment, the multiple manufacturing parameters include the multiple virtual adjusted parameters Rec-v and the multiple physical adjusted parameters Rec-p. The processor 110 refers to the multiple virtual adjusted parameters Rec-v and the multiple physical adjusted parameters Rec-p to execute the virtual machine-tuning program 137 (step S540).

Accordingly, the machine-tuning system and the machine-tuning method for integrating the virtual simulations and the physical operations of the disclosure implements the same operation programming interface, so the users may just handle the same set of program codes to respectively control the machine-tuning of the virtual machines and the physical machines, without programming the virtual machine-tuning program for controlling the virtual machines first and then transforming the virtual machine-tuning program to the physical machine-tuning program for the physical machines. By fast switching between the machine-tuning programs of the virtual machines and the physical machines, the time spent on the programming development is largely shortened, and the utilization rate of the physical machines is largely improved. In addition, the simulated virtual machine-tuning program involves the determination of the exception events handling, so the interactivity of the machine-tuning program is engaged. Furthermore, the determination of the exception events handling may be also applied to the operations of the physical machines to decrease the probability of the occurrence of danger during the actual physical operations, so the safety that the physical machines work is maintained.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A machine-tuning system for integrating virtual simulations and physical operations, comprising:
an operation programming interface, configured to provide virtual-physical synchronous operation pseudo-codes based on a software framework, wherein the virtual-physical synchronous operation pseudo-codes comprise pseudo-codes that process an interactive event operating process and the software framework is compatible with virtual machine drivers and physical machine drivers; and
a processor, configured to import the virtual machine drivers into the virtual-physical synchronous operation pseudo-codes and compile the virtual-physical synchronous operation pseudo-codes and the virtual machine drivers to be a virtual machine-tuning program, execute the virtual machine-tuning program to control virtual operations of virtual machines in a 3D virtual environment, and import the physical machine drivers into virtual-physical synchronous operation pseudo-codes and compile the virtual-physical synchronous operation pseudo-codes and the physical machine drivers to be a physical machine-tuning program, execute the physical machine-tuning program to control physical operations of physical machines, so a logic of the physical operations of the physical machines and the logic of the virtual operations of the virtual machines in the 3D virtual environment is the same.

2. The machine-tuning system for integrating virtual simulations and physical operations of claim 1, wherein the operation programming interface comprises a flag, and the flag points to the virtual machine drivers or the physical machine drivers;
wherein when the flag points to the virtual machine drivers, the processor is configured to import the virtual machine drivers into the virtual-physical synchronous operation pseudo-codes and compile the virtual-physical synchronous operation pseudo-codes and the virtual machine drivers to be the virtual machine-tuning program; and
when the flag points to the physical machine drivers, the processor is configured to import the physical machine drivers into the virtual-physical synchronous operation pseudo-codes and compile the virtual-physical synchronous operation pseudo-codes and the physical machine drivers to be the physical machine-tuning program.

3. The machine-tuning system for integrating virtual simulations and physical operations of claim 1, wherein the processor is configured to input multiple manufacturing parameters to the virtual machine-tuning program and use the multiple manufacturing parameters to execute virtual machine-tuning program and adjust operation processes of the virtual machines in the 3D virtual environment.

4. The machine-tuning system for integrating virtual simulations and physical operations of claim 1, wherein the processor is configured to input multiple manufacturing parameters to the physical machine-tuning program, use the multiple manufacturing parameters to execute the physical machine-tuning program, and adjust the physical operations of the physical machines in a physical environment.

5. The machine-tuning system for integrating virtual simulations and physical operations of claim 3, wherein when executing the virtual machine-tuning program, the processor is configured to adjust the multiple manufacturing parameters to obtain multiple virtual adjusted parameters of the 3D virtual environment, update the multiple virtual adjusted parameters to the virtual machine-tuning program and output the multiple virtual adjusted parameters.

6. The machine-tuning system for integrating virtual simulations and physical operations of claim 5, wherein when executing the physical machine-tuning program, the processor is configured to input the multiple manufacturing parameters to the physical machine-tuning program, wherein the multiple manufacturing parameters comprise the multiple virtual adjusted parameters, and the processor is configured to use the multiple manufacturing parameters to execute the physical machine-tuning program and determine the physical operations of the physical machines in an actual physical environment.

7. The machine-tuning system for integrating virtual simulations and physical operations of claim 4, wherein when executing the physical machine-tuning program, the processor is configured to adjust the multiple manufacturing parameters to obtain multiple physical adjusted parameters of the physical machines, update the multiple physical adjusted parameters to the physical machine-tuning program and output the multiple physical adjusted parameters.

8. The machine-tuning system for integrating virtual simulations and physical operations of claim 7, wherein when executing the virtual machine-tuning program, the processor is configured to input the multiple manufacturing parameters to the virtual machine-tuning program, wherein the multiple manufacturing parameters comprise the multiple physical adjusted parameters, and the processor is configured to use the multiple manufacturing parameters to execute the virtual machine-tuning program and determine the operation processes of the virtual machines in the 3D virtual environment.

9. The machine-tuning system for integrating virtual simulations and physical operations of claim 1, wherein the processor is configured to execute the virtual machine-tuning program and determine whether the interactive event operating process is triggered in the 3D virtual environment, wherein the interactive event operating process comprises detecting collisions of the virtual machines, foreign object dropping, raw material exhaustion, or triggering safety door, and the processor is configured to pause the virtual machine-tuning program by the interactive event operating process to clear faults, and re-execute the virtual machine-tuning program after an exception event is clear.

10. The machine-tuning system for integrating virtual simulations and physical operations of claim 9, wherein when executing the virtual machine-tuning program, the processor is configured to adjust multiple virtual adjusted parameters of the virtual machines by the interactive event operating process, update the multiple virtual adjusted parameters to the virtual machine-tuning program to continuously detect the virtual machines; and when executing the physical machine-tuning program, the processor is configured to adjust multiple physical adjusted parameters of the physical machines by the interactive event operating process, and update the multiple physical adjusted parameters to the physical machine-tuning program to continuously detect the physical machines.

11. A machine-tuning method for integrating the virtual simulations and the physical operations, applied to simulated operations and actual physical operations of a unitary interface of virtual machines and physical machines, comprising:
providing virtual-physical synchronous operation pseudo-codes based on a software framework, wherein the virtual-physical synchronous operation pseudo-codes comprise pseudo-codes that process an interactive event operating process and the software framework is compatible with virtual machine drivers and physical machine drivers;
importing the virtual machine drivers into the virtual-physical synchronous operation pseudo-codes and importing the physical machine drivers into virtual-physical synchronous operation pseudo-codes;
compiling the virtual-physical synchronous operation pseudo-codes and the virtual machine drivers to be a virtual machine-tuning program, and compiling the virtual-physical synchronous operation pseudo-codes and the physical machine drivers to be a physical machine-tuning program; and
executing the virtual machine-tuning program to control virtual operations of virtual machines in a 3D virtual environment, and executing the physical machine-tuning program to control physical operations of physical machines, so a logic of the physical operations of the physical machines and the logic of the virtual operations of the virtual machines in the 3D virtual environment is the same.

12. The machine-tuning method for integrating the virtual simulations and the physical operations of claim 11, wherein a flag is provided after providing the virtual-physical synchronous operation pseudo-codes, and the flag points to the virtual machine drivers or the physical machine drivers, and the method comprises:
when the flag points to the virtual machine drivers, importing the virtual machine drivers into the virtual-physical synchronous operation pseudo-codes and compiling the virtual-physical synchronous operation pseudo-codes and the virtual machine drivers to be the virtual machine-tuning program; and
when the flag points to the physical machine drivers, importing the physical machine drivers into the virtual-physical synchronous operation pseudo-codes and compiling the virtual-physical synchronous operation pseudo-codes and the physical machine drivers to be the physical machine-tuning program.

13. The machine-tuning method for integrating the virtual simulations and the physical operations of claim 11, further comprising:
inputting multiple manufacturing parameters to the virtual machine-tuning program to use the multiple manufacturing parameters to execute the virtual machine-tuning program and adjusting the operation processes of the virtual machines in the 3D virtual environment.

14. The machine-tuning method for integrating the virtual simulations and the physical operations of claim 11, further comprising:
inputting multiple manufacturing parameters to the physical machine-tuning program to use the multiple manufacturing parameters to execute the physical machine-tuning program and adjusting the physical operations of the physical machines in a physical environment.

15. The machine-tuning method for integrating the virtual simulations and the physical operations of claim 13, further comprising:
when executing the virtual machine-tuning program, adjusting the multiple manufacturing parameters to obtain the multiple virtual adjusted parameters in the 3D virtual environment, updating the multiple virtual adjusted parameters to the virtual machine-tuning program, and outputting the multiple virtual adjusted parameters.

16. The machine-tuning method for integrating the virtual simulations and the physical operations of claim 15, further comprising:
when executing the physical machine-tuning program, inputting the multiple manufacturing parameters to the physical machine-tuning program, wherein the multiple manufacturing parameters comprise the multiple virtual adjusted parameters, and using the multiple manufacturing parameters to execute the physical machine-tuning program to detect the physical machines in an actual physical environment.

17. The machine-tuning method for integrating the virtual simulations and the physical operations of claim 14, further comprising:
when executing the physical machine-tuning program, adjusting the multiple manufacturing parameters to obtain multiple physical adjusted parameters of the physical machines, updating the multiple physical adjusted parameters to the physical machine-tuning program, and outputting the multiple physical adjusted parameters.

18. The machine-tuning method for integrating the virtual simulations and the physical operations of claim 17, further comprising:
when executing the virtual machine-tuning program, inputting the multiple manufacturing parameters to the virtual machine-tuning program, using the multiple manufacturing parameters to execute the virtual machine-tuning program, and determining the operation processes of the virtual machines in the 3D virtual environment; wherein the multiple manufacturing parameters comprise the multiple physical adjusted parameters.

19. The machine-tuning method for integrating the virtual simulations and the physical operations of claim 11, further comprising:
executing the virtual machine-tuning program and determining whether the interactive event operating process is triggered in the 3D virtual environment, pausing the virtual machine-tuning program by the interactive event operating process to clear faults, and re-executing the virtual machine-tuning program after an exception event is clear, wherein the interactive event operating process comprises detecting collisions of the virtual machines, foreign object dropping, raw material exhaustion, or triggering safety door.

20. The machine-tuning method for integrating the virtual simulations and the physical operations of claim 19, further comprising:
when executing the virtual machine-tuning program, adjusting multiple virtual adjusted parameters of the virtual machines by the interactive event operating process, and updating the multiple virtual adjusted parameters to the virtual machine-tuning program to continuously detect the virtual machines; and
when executing the physical machine-tuning program, adjusting multiple physical adjusted parameters of the physical machines by the interactive event operating process, and updating the multiple physical adjusted parameters to the physical machine-tuning program to continuously detect the physical machines.
